(19) United States
(12) Patent Application Publication
(10) Pub. No.: US 2010/0040222 A1
(43) Pub. Date: Feb. 18, 2010

(54) Queuing System, Method And Device

(75) Inventors: John Anderson, Glasgow (GB); Eddie Keane, Greenock (GB); Rob Walker, Glasgow (GB); Paul McCready, Glasgow (GB)

Correspondence Address: EDWARDS ANGELL PALMER & DODGE LLP, P.O. BOX 55874, BOSTON, MA, 02205, US

(73) Assignee: VERSKO LIMITED, GLASGOW (GB)

(21) Appl. No.: 12/225,135

(22) PCT Filed: Mar. 15, 2007
(86) PCT No.: PCT/GB2007/000952

§ 371 Date: Oct. 16, 2009

Related U.S. Application Data
(60) Provisional application No. 60/815,763, filed on Jun. 22, 2006.

(30) Foreign Application Priority Data
Mar. 16, 2006 (GB) 0605282.3

(51) Int. Cl. H04M 3/00

(52) U.S. Cl. 379/266.01

(57) ABSTRACT

A system and method for managing requests for service from customer terminals (3, 5) via a website. A request for service is received at a queue manager (9) via a communications channel and is either passed to a service manager for processing or placed in a queue depending upon whether one or more applications associated with the service manager (17) are connected to an allowable number of customer terminals such that, where the request is placed in a queue the communications channel between the customer terminal and the queue manager is held open whilst the customer terminal is held in the queue. The invention allows a more efficient throughput of users/customers on a website. In addition, because the website is less likely to fail and customers are informed of their place in a queue, the usability of the website is increased and customers are more likely to select a website that incorporates the present invention for buying concert tickets, on-line shopping system, or in other application areas including, but not limited to e-commerce, retail or information services.

The present invention relates to a queuing system method and device and in particular to one which provides improved website performance by managing client terminal demand and client terminal access to a website.

Any service provided by a computer system over a communications network will have limited capability, resulting in a maximum number of customers that can be served per minute. The capability may be limited for technical reasons, such as web service speed or the number of available connections, or may be limited because there are not enough operators to handle the demand for service.

Excessive demand often occurs in e-commerce when there is a very high interest in a particular product, which may be available in limited quantities when it first goes on sale. A typical example is the selling of concert tickets using an e-commerce system. Fans, knowing that tickets are limited, will all try to use the system as soon as the tickets go on sale, creating a demand “spike” that may well be above the maximum transaction rate that the system can cope with.

A customer participating in an on-line purchase typically follows the following steps:

1. The customer browses a website, making requests and reading responses using web browsing software. The pages of the website are normally transferred from the web server to the customer's client machine using unencrypted hypertext transfer protocol (HTTP).

2. When they have made a choice, the customer requests a payment page, usually by pressing a “buy” button, containing form fields in which they can enter their credit/debit card information. This payment page is normally transferred over the network using secure HTTP (HTTPs).

3. The customer fills in his/her details, and these are sent using HTTPs to a payment gateway. Frequently, the pending transaction is stored in a database. The payment gateway forwards the transaction details onto a dedicated credit card network for processing. Assuming that the transaction is authorised, the transaction is stored on a database attached to the payment page and the original web server.

4. The customer is presented with a response indicating that his or her transaction is successful. Usually a confirmation email is also sent to the customer.

In general, the problem with too many customer terminals such as web browsers trying to access a computer system is that the computer system tries to process all the requests for service one after another at very high speed. As it becomes busy and reaches its transactional limit (the maximum capability) the computer system denies service to any customer terminal. Consequently, the customer terminal tries again until it is answered. This causes unnecessary repeat requests that exacerbate the situation, creating more load. Eventually the core system grinds to a near halt, or suffers a total failure of service

In other words, as the volume of the requests for service increases, the system becomes loaded and has to use ever more resources to distinguish between users re-visiting the core system as part of a larger transaction, and new users. As long as the volume does not exceed capacity, performance is fine. When it exceeds capacity, a downward spiral of performance occurs which can lead to core system failure.

The server load means that attempts to modify the pages to improve the system “on the fly” may not succeed. If the high load has been anticipated, certain checks (such as credit card authorisation) may be postponed until after the ‘sale’ to increase performance, causing further work and uncertainty as to the number of tickets actually sold. The server load means that attempts must be made to increase capacity at an additional cost to the vendor and ultimately to the customer. Additional staff must also be hired to cope with the influx of orders and these staff members will have less time to deal with dissatisfied customers.

Users of customer terminals get frustrated particularly if they are half way through a process and in the middle of a sequence of steps the core system gets slower and slower and eventually stops working leaving the user with (i) a half completed transaction (ii) one the user had thought he had completed but had not (iii) or one that had been partially completed but which the user thought had not been partially completed.

All these scenarios result in dissatisfied users. The wrong data may be displayed to the user, and payment may be taken for on-line purchases that have not had logistics or delivery data passed to the correct department or systems.

These systems, particularly those created using Internet technology, work on stateless connection technology. This means that connections (or requests for service) between the customer terminal and system components and between the components are switched on ‘on request’ and switched off when the connection is not needed. Stateless systems allow internet based solutions to transact with many more users than previous architectures (such as client-server connections) could manage.

Limits of processing are created by a combination of bandwidth (the connection speed between the core system and user), any hardware component of the core system (such as Database Server, Application Server, Web Server, Payment Server, Content Server), Firewall, Load Balancer or any software component (Database, Application Server, Web Server or Bespoke code).

WO2005/112389 discloses a queuing system for managing the provision of services over a communications network. The system provides means for allocating a queue identifier to a request for service and for comparing queue status information and the queue identifier during a subsequent request for service. WO2005/112389 also discloses a means for performing a comparison which determines whether the request for service will be sent to a service host or placed in a managed queue. This document describes a system in which the user is able to make a request for service then disconnect whilst maintaining or being able to resume their place in the queue.

However, it is believed that many firewalls may prevent the user from re-entering the server thus reducing the effectiveness of this queuing system.

It is an object of the present invention to provide an improved queuing system to improve the management of access to applications accessible via the internet.

In accordance with a first aspect of the invention there is provided a system for managing requests for a service from one or more customer terminals, the system comprising:

a queue manager for receiving the requests for the service from the one or more customer terminals via one or more communications channels, the queue manager being adapted to place the requests for service in an ordered queue;

a service manager, responsive to the request for service, the service manager being adapted to deliver the service to the one or more customer terminals by means of one or more applications;

communication means adapted to pass data between the queue manager and the service manager, the data being related to an allowable volume of customer terminals granted access to the service manager;

wherein the queue manager holds the customer terminals not granted access to the service manager in the ordered queue once the allowable volume of customer terminals granted access to the service manager is reached and the communications channels between the queue manager and the customer terminals not granted access to the service manager are held open whilst the customer terminals are held in the ordered queue.

Preferably, the queue manager is connected to one or more software applications defined as being non-core applications.

Preferably, the queue manager is a server.

Preferably, each of the one or more customer terminals connected to the queue manager are uniquely identified when placed in the ordered queue.

Preferably, the queue manager comprises:

a request receiver for receiving a request for the service from the one or more customer terminals via the one or more communications channels; and

a customer manager for receiving data on the volume of customer terminals connected to the service manager, the data defining the allowable volume of customer terminals granted access to the service manager;

wherein the queue manager is adapted to hold open the communications channel with the customer terminal whilst the customer terminal is held in the queue.

Preferably, the communications channel between each of the customer terminals and the queue manager is routed through a firewall.

Preferably, the firewall grants the connection between the customer terminal and the queue manager if capacity is available.

Preferably, the service manager is connected to one or more software applications defined as being core applications.

The definition of what are core and non-core applications is flexible and can be change depending upon circumstances. The definition may depend upon the load the service provider expects on their website. Accordingly, an application can be defined as non-core in one configuration of a system of the present invention and as core in another configuration.

Preferably, the service manager is a server.

Alternatively, the queue manager and the service manager are contained in the same server.

Preferably, the communication means sends data to the queue manager which calculates the allowable volume of customer terminals granted access to the service manager and determines whether a customer terminal in the ordered queue can pass to the core applications.

Optionally, the communications means sends data on the allowable volume of customer terminals which has been calculated by the service manager such that the queue manager determines whether a customer terminal in the ordered queue can pass to the core applications.

The client terminal cannot have concurrent places in the queue, but can re-join the queue after leaving the queue.

Preferably a token is issued to the client terminal on leaving the queue to allow the client terminal to access the one or more core applications.

Preferably, the token is issued via the queue manager.

Preferably, the token is issued by the one or more core applications.

Preferably, the token is returned to the system after the client terminal has exited from the one or more core application.

Preferably, the token holds a unique identifier. The unique identifier may be used to stop multiple queue entries from a single customer terminal. The token identifier may be compared to previous token unique identifiers and suspected duplicates denied access through the gate.

Optionally, the unique identifier includes the customer terminal MAC address.

Preferably, the communications channel is kept open by sending data to the customer terminal periodically.

Preferably, the queue manager sends the data to the customer terminal.

Preferably, the data comprises information on the position of the customer terminal in the queue.

Preferably, the amount of data transferred is significantly less than that transferred when refreshing an internet page.

Preferably, less than one kilobyte of data is transferred.

More preferably, less than 100 bytes of data is transferred.

Advantageously, by transferring a small amount of data, a minimal amount of bandwidth is required to keep open each of the communication channels used in the ordered queue. It is possible to send around 5 bytes of data.

Preferably, the queue manager measures the position in the ordered queue against the instantaneous number of tokens issued within a time frame to calculate the amount of time the customer terminal is likely to have to wait before receiving a token.

Preferably, the data sent to the customer terminal comprises the amount of time the customer terminal is likely to have to wait before receiving a token.

Preferably, the data sent to the customer terminal further comprises the position of the client terminal in the queue.

The system may also logs detailed performance data about the applications associated with the service manager.

The system of the present invention can monitor patterns of events to provide detailed logs that can be post processed and replayed enabling measurement of the events that can lead to system failure. This data may be used to set alarms for a system administrator.

Preferably, multiple queues can be controlled by the system.

Preferably, preference can be given to customer terminals located on one of said multiple queues.

For example subscribers or loyalty club members can have their own separate queue through the queue manager.

Alternatively, queues from a plurality of web sites or sections of separate sites may be merged into a single queue.

A method for managing requests for service from a customer terminal, the method comprising the steps of:

receiving a request for service at a queue manager via a communications channel;

either passing the request to a service manager for processing or placing the request in a queue depending upon whether one or more applications associated with the service manager are connected to an allowable number of customer terminals;

such that, where the request is placed in a queue the communications channel between the customer terminal and the queue manager is held open whilst the customer terminal is held in the queue.

Preferably, the queue manager is connected to one or more software applications defined as being non-core applications.

Preferably, each of the customer terminals connected to the queue manager are uniquely identified when placed in the ordered queue.

Preferably, the communications channel that connects the customer terminals and the queue manager is routed through a firewall.

Preferably, the firewall grants the connection between the customer terminal and the queue manager if capacity is available.

Preferably, the service manager is connected to one or more core applications.

Preferably, the allowable volume of customer terminals is calculated to determine whether a customer terminal in the ordered queue can pass to the core applications.

Optionally, data is sent by the communications means said data relating to the allowable volume of customer terminals which has been calculated by the service manager such that the queue manager determines whether a customer terminal in the ordered queue can pass to the core applications.

Preferably a token is issued to the client terminal on leaving the queue to allow the client terminal to access the one or more application associated with the service manager.

Preferably, the token is issued via the queue manager.

Preferably, the token is issued by the one or more application associated with the service manager.

Preferably, the token is returned to the system after the client terminal has exited from the applications associated with the service manager.

Preferably, the token holds a calculated unique identifier. The unique identifier may be used to stop multiple queue entries. The token identifier may be compared to previous token unique identifiers and suspected duplicates denied access through the gate.

Optionally, the unique identifier includes the customer terminal MAC address.

Preferably, the communications channel is kept open by sending data to the customer terminal periodically.

Preferably, data is sent from the queue manager to the customer terminal.

Preferably, the data comprises information on the position of the customer terminal in the queue.

Preferably, the amount of data transferred is significantly less than that transferred when refreshing an internet page.

Preferably, less than one kilobyte of data is transferred.

More preferably, less than 100 bytes of data is transferred.

Preferably, the position in the ordered queue is measured against the instantaneous number of tokens issued within a time frame to calculate the amount of time the customer terminal is likely to have to wait before receiving a token.

Preferably, the data sent to the customer terminal comprises the amount of time the customer terminal is likely to have to wait before receiving a token.

Preferably, the data sent to the customer terminal further comprises the position of the client terminal in the queue is also shown.

The system may also logs detailed performance data about the applications associated with the service manager.

Preferably, multiple queues can be controlled by the system.

Preferably, preference can be given to customer terminals located on one of said multiple queues.

Alternatively, queues from a plurality of web sites or sections of separate sites may be merged into a single queue.

A queue manager server comprising:

a request receiver for receiving a request for service from a customer terminal via a communications channel; and

a customer manager for receiving data on the volume of customer terminals connected to a service manager, the data defining an allowable number of customer terminals granted access to the service manager;

wherein the queue manager server is adapted to hold open the communications channel with the customer terminal whilst the customer terminal is held in a queue.

Preferably, the queue manager is connected to one or more software applications defined as being non-core applications.

Preferably, each of the customer terminals connected to the queue manager are uniquely identified when placed in the ordered queue.

Preferably, unique connection of each of the customer terminals is provided by a firewall.

Preferably, the queue manager server is connectable to a service manager located on a client web server, the service manager being connected to one or more software applications defined as being core applications.

Preferably, a communications means sends data to the queue manager which calculates the allowable volume of customer terminals and determines whether a customer terminal in the ordered queue can pass to the core applications.

Preferably a token is issued to the client terminal on leaving the queue to allow the client terminal to access the one or more applications associated with the service manager.

Preferably, the token is issued via the queue manager.

Preferably, the token is issued by the one or more application associated with the service manager via the queue manager.

Preferably, the token is returned to the system after the client terminal has exited from the applications associated with the service manager.

Preferably, the token holds a calculated unique identifier. The unique identifier may be used to stop multiple queue entries. The token identifier may be compared to previous token unique identifiers and suspected duplicates denied access through the gate.

Optionally, the unique identifier includes the customer terminal MAC address.

The system of the present invention can be used as an on-line shopping system, or in other application areas including, but not limited to e-commerce, retail or information services.

Preferably, the communications channel is kept open by sending data to the customer terminal periodically.

Preferably, the queue manager sends the data to the customer terminal.

Preferably, the data comprises information on the position of the customer terminal in the queue.

Preferably, the amount of data transferred is significantly less than that transferred when refreshing an internet page.

Preferably, less than one kilobyte of data is transferred.

More preferably, less than 100 bytes of data is transferred.

Advantageously, by transferring a small amount of data, a minimal amount of bandwidth is required to keep open each of the communication channels used in the ordered queue.

Preferably, the queue manager measures the position in the ordered queue against the instantaneous number of tokens issued within a time frame to calculate the amount of time the customer terminal is likely to have to wait before receiving a token.

The figure may for example be 50 per minute. In which case, if a client terminal was 170^{th} in the queue they would be served in approximately 3 minutes and 24 seconds.

Preferably, the data sent to the customer terminal comprises the amount of time the customer terminal is likely to have to wait before receiving a token.

Preferably, the data sent to the customer terminal further comprises the position of the client terminal in the queue is also shown.

The system may also logs detailed performance data about the applications associated with the service manager.

The system of the present invention can monitor patterns of events to provide detailed logs that can be post processed and replayed enabling measurement of the events that can lead to system failure. This data may be used to set alarms for a system administrator.

Preferably, multiple queues can be controlled by the system.

Preferably, preference can be given to customer terminals located on one of said multiple queues.

Alternatively, queues from a plurality of web sites or sections of separate sites may be merged into a single queue.

The present invention will now be described by way of example and with reference to the accompanying drawings in which:

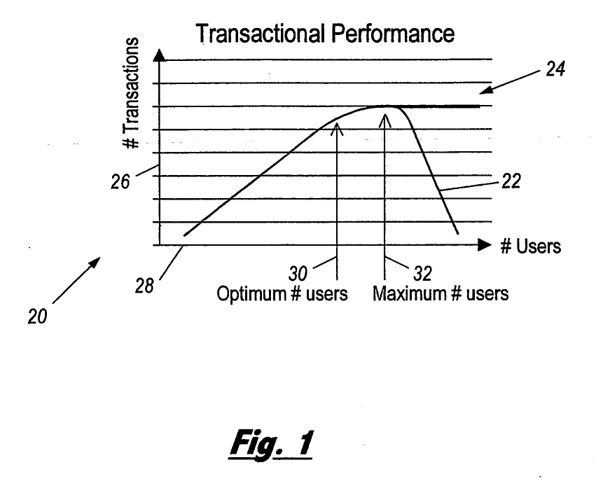

FIG. 1 is a graph which shows transactional performance (load) on a web server

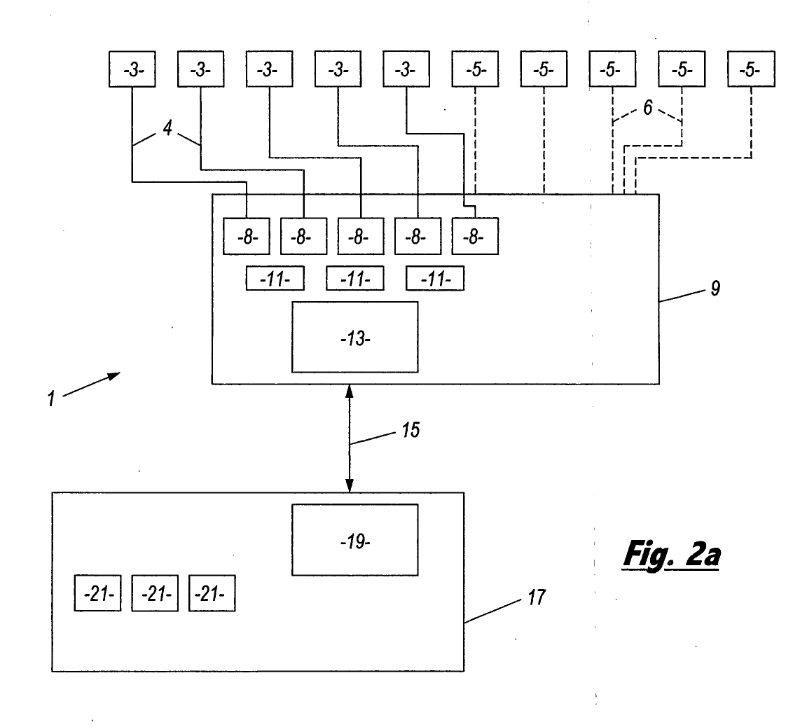

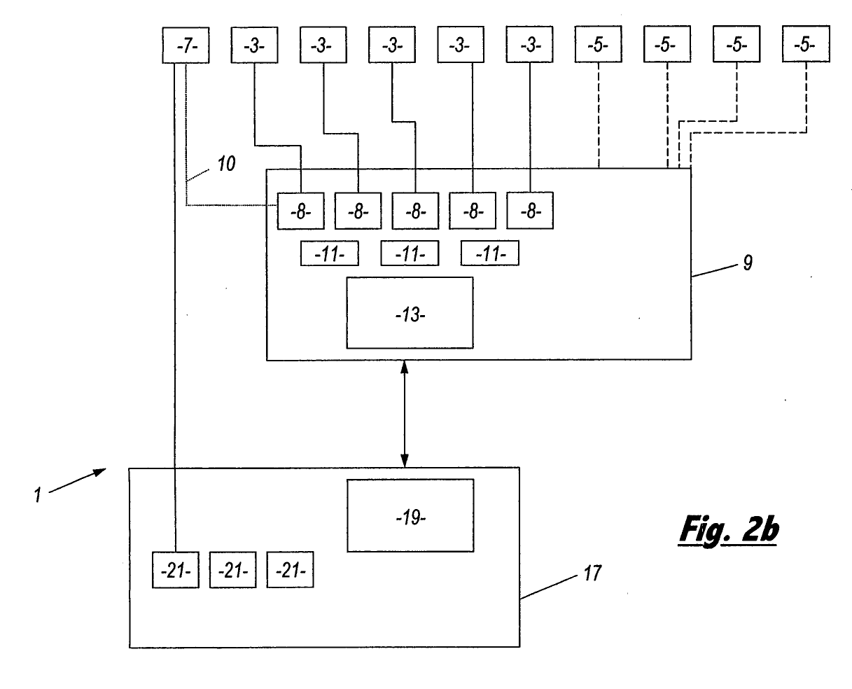

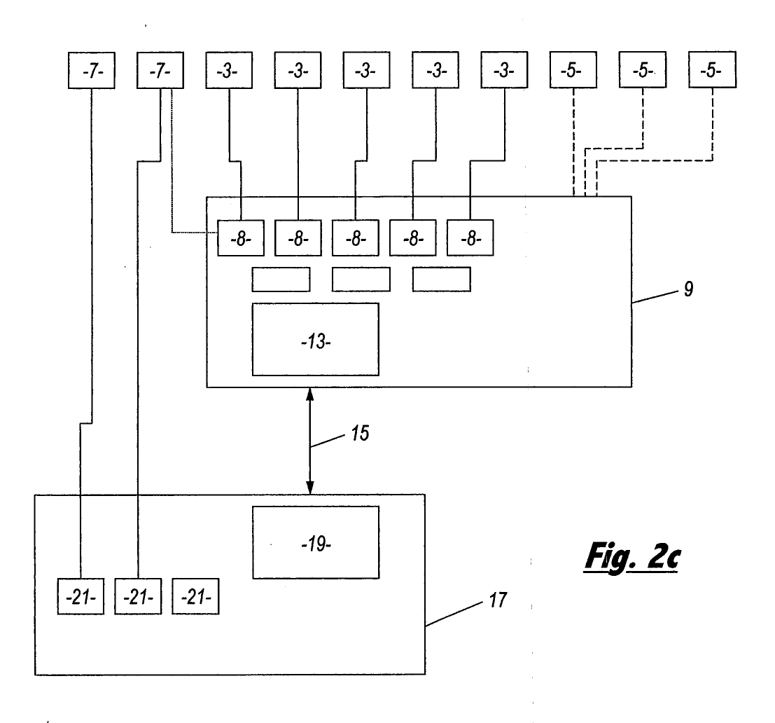

FIGS. 2(a) to 2(c) show a block diagram of a first embodiment of the present invention;

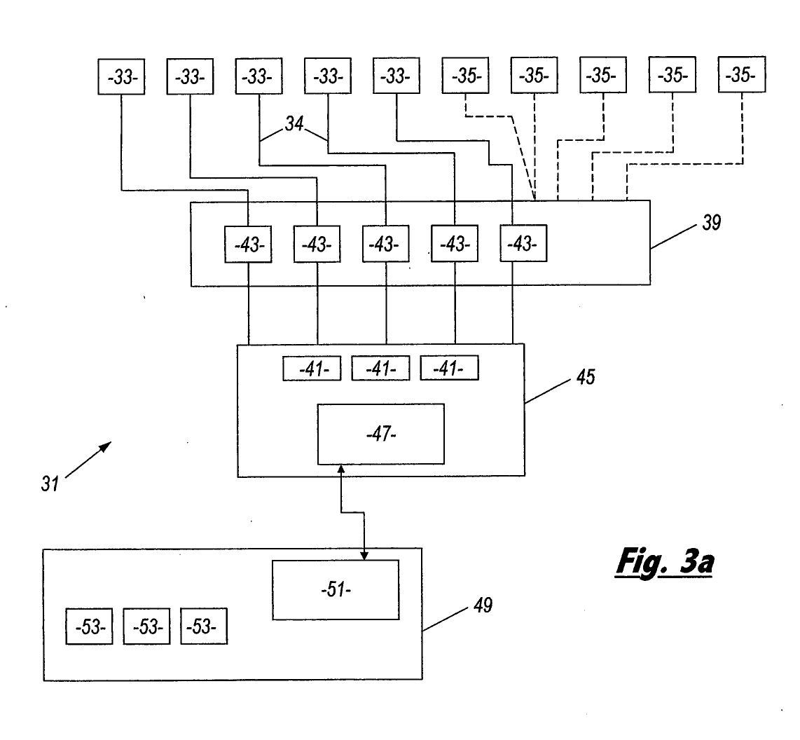

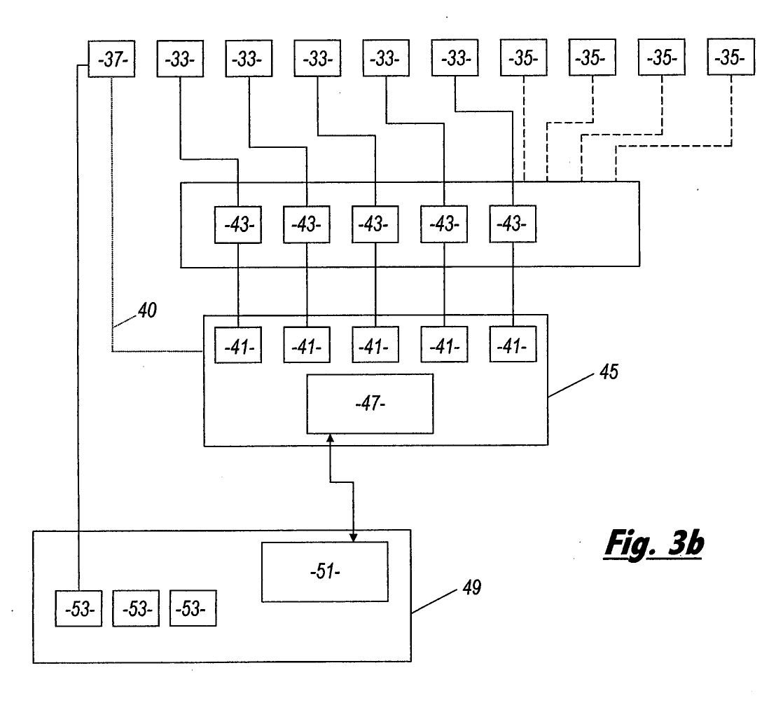

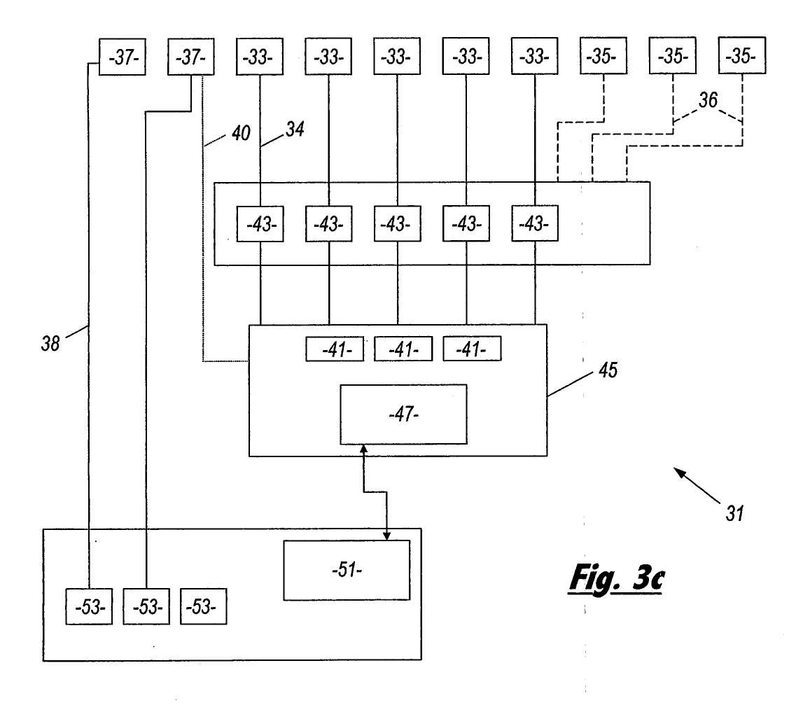

FIGS. 3(a) to 3(c) show a block diagram of second embodiment of the present invention; and

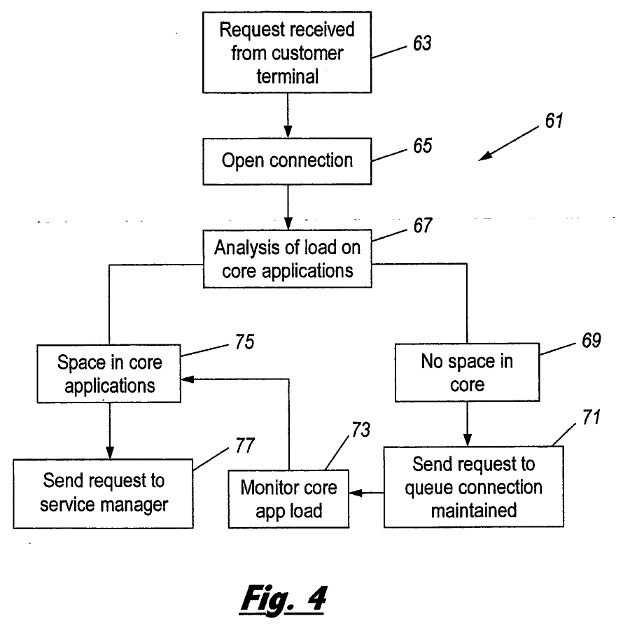

FIG. 4 is a flow diagram that illustrates the method of the present invention.

The system of the present invention may be used in e-commerce, for example by supermarkets or online ticket vendors. In addition, the system of the present invention may be used by any organisation which experiences or expects to experience a high volume of hits on their website or on part of their website for any reason.

The present invention allows the website owner to classify some applications on their website as core applications and some applications on their website as non-core applications. The non-core applications are those which a user who is using a customer terminal is able to browse prior to entering a queue and the core application are those which the users can only access after having been in the queue if a pre-defined maximum load on the core applications has been reached.

The customer terminal may be a personal computer, personal cellular telephone or any device capable of making an internet connection to a website.

FIG. 1 is a graph which shows transactional performance (load) on a web server by plotting the number of transactions 26 against the number of users 28. In the case of state of the art, the optimum 30 and maximum 32 number of users of the system is shown with respect to points on curve 22. The system's downward spiral of performance begins in the area of the graph after the optimum transaction values on curve 22. The flat curve 24 shows the performance of a system in accordance with the present invention.

In the examples of FIGS. 2(a) to 2(c), a system 1 is shown having ten customer terminals denoted by reference numerals 3, 5 and 7. The customer terminals are connected to a queue manager module 9 which can be loaded on a central server. The reference numeral 3 denotes customer terminals which are contained within a queue, the customer terminals 5 are those which have been unable to obtain access to the system and the customer terminals 7 (FIG. 2b) are those which have access to the core applications 21 via the service manager 17.

The customer terminals 3 which are connected to the queue manager 9 are connected via a socket connection 11. Once connected to the queue manager 9, the customer terminals 3 may access one or more non-core applications 12. Such non-core applications may typically be the home page of a website or other pages where it is anticipated that a low number of users will attempt to gain access to the specific pages.

Within the queue manager module 9 there is a customer manager module 13 which in this example is configured to communicate with the service manager 17 and particularly the throughput manager module 19 contained within the service manager 17. The customer manager module is configured to send small amounts of information, typically less than 100 bytes and often less than 10 bytes, to each customer held in the queue. This information concerns the length of time that the customer terminal will be held in the queue and the position of the customer terminal within the queue. This data is pushed to the customer periodically and acts to keep the socket connection between the customer terminal 3 and the socket 11 of the queue manager 9 open so that the customer terminal is in the queue. The frequency at which the data is pushed can be set by the system to ensure that the connection between the customer terminal and the queue manager is maintained.

In addition, the customer manager module assists with measurement of the position in the queue against the instantaneous number of tokens issued by the core applications 21 via the queue manager 9. In one example 50 tokens per minute were issued. Therefore, a user who is 170^{th} in a queue would be served in approximately 3 minutes 24 seconds.

The customer manager 13 of the queue manager 9 also receives data on the load experienced by the core applications 21. This data is gathered by the throughput manager 19 and provided via the communications link 15 to the customer manager 13. In one example of the present invention, data on the load experienced by the core applications 21 is processed by the throughput manager 19 and communicated to the customer manager 13.

In another example of the present invention, core application load data is passed to the customer manager 13 via the throughput manager 19 without being processed and all the processing of this data to determine whether the core applications have exceeded or met a pre-defined maximum load or use account is done by the customer manager 13.

In addition, it will be appreciated that the number of users that may be attached to the queue in the system is determined by the number of one to one socket connections between the queue manager system and the customer terminals that wish to have access to the system.

Advantageously, as the present invention pushes a small amount of data to each customer terminal (often as little as 5 bytes) the system can maintain connections to individual customer terminals using a very low bandwidth. Therefore, a large number of customer terminals may be connected to the system at any one time.

One example of a use of the system of FIG. 2 will now be described.

FIG. 2a shows 10 customer terminals. Each of the users of these terminals wishes to use a website. As described above, the contents of the website can be divided into core applications and non-core applications. The users enter the website via a queue manager 9 which contains a number of non-core software applications associated with the website. The queue manager 9 communicates with the service manager 17 (which contains the core applications). The service manager 17 measures throughput and provides data to the queue manager on whether the applications associated with the service manager have spare capacity. If there is no spare capacity, users are held in an ordered queue.

Typically the first customer terminal entering the queue will be the first one to leave once there is spare capacity in the core application.

In order for the customer terminal 3 to maintain its place in the queue, the communications line 4 between the customer terminal and the queue manager 9 is kept open whilst the customer terminal 3 is in the queue. In addition, whilst the customer terminal 3 is in the queue, a message is pushed to the customer terminal 3 informing it of its position in the queue and the length of time the system expects it to take to serve the customer.

In addition, the customer manager 13 of the queue manager 9 checks for spare capacity by communicating with the service manager 17. This spare capacity is available when a token is sent from the application to the customer terminal via the queue manager 9. Once the customer 7 terminal 7 has received the token, it is able to connect to the core application 21.

FIG. 2(b) shows the process whereby a customer terminal changes status from one which is queued (denoted by reference numeral 3 FIG. 2a) to one which has gained access to the core application (denoted by reference numeral 7 FIG. 2b). In addition, once this customer terminal has gained access to the core applications 21 a space opens up in the queue to allow an additional customer terminal to enter the queue. It will be noted that FIG. 2(a) contains five customer terminals that were unable to gain access to the queue manager whereas FIG. 1(b) contains four such customer terminals 5.

FIG. 2(c) shows a further progression of the use of the system whereby the customer terminal second from the left in FIG. 2(c) is provided with a token as described above and also gains access to one of the core applications 21. As with FIG. 2(b) another customer terminal is added to the queue to take up the empty space vacated by the second customer terminal 7 and this figure shows only three customer terminals who are unable to connect to the queue manager.

FIGS. 3(a) to 3(c) show a second embodiment of the present invention in which the queue manager functionality is contained within the queue manager 45 and in a firewall. It is known that firewalls are good at granting and refusing access to systems and as such they can be used to grant and deny access in the queue manager of the present invention.

As with FIGS. 2(a) to 2(c), the system 31 of FIGS. 3(a) to 3(c) shows queued customer terminals 33, non queued customer terminals 35 and customer terminals that obtained access to the core applications 37. The queue manager 45 comprises a customer manager 47 and a number of applications 42. The service manager 49 comprises the output manager 51 and a number of core applications 53.

It will be appreciated that in both embodiments of the present invention, the service manager may be a software module loaded onto a server which operates an existing customer website.

In another embodiment of the present invention, multiple queues can be controlled by the system. For example, where it is desirable to protect more than one core application and to have customer terminals queued separately for these applications, separate queues can be created. In addition, multiple queues can be used to provide a subset of users and to provide preferential access for one set of users.

For example, a supermarket with a customer loyalty scheme may use the present invention to allow a customer owning a loyalty card or ID number to obtain preferential treatment and quicker access to various parts of their website. As well as rewarding loyalty, this type of use of the present invention may provide an excellent marketing tool for the supermarket and may encourage customers to sign up to enhanced loyalty schemes. Similar schemes can be adopted by events ticketing vendors or other website owners.

Conversely, where two or more sites or sections of separate sites provide access to a single type of service then it is possible for queues to be merged. For example, where a number of different sites all provide access to tickets for a single event, then access to the tickets through the sites can be controlled by a single queue by merging the queues together. Once the queues are merged it may also be possible to differentiate between members of the queue by recognising the website from which they entered the queue.

In a further embodiment of the invention, the system is configured to stop multiple queue entries by holding a unique identifier in the token. The unique identifier will be associated with the user terminal by, for example, incorporating features of the terminal's MAC address so that no two queue identifiers with the same MAC address can be issued with an approved timeframe.

FIG. 4 shows an embodiment of the method of the present invention 61. The method begins when a request for service 63 is received from a customer terminal. Thereafter a connection is opened 65 and an analysis 67 of the load on core applications is conducted. If there is no space in the core applications 69 the request is sent to the queue 71 and the connection between the customer terminal and the system kept open.

The load on the core applications is monitored 73 and when space becomes available 75 the customer terminal is provided with a token and the request is sent to the core application.

Advantageously, the present invention keeps a core system working at maximum capacity improving efficiency and retuning maximum revenue from the core system. Customer terminals are queued on a (first in first out) FIFO basis and this is perceived to be fairer that the apparently random chances of access provided in many existing systems.

The present invention creates a stateful connection between client terminals and the queue in a stateless environment. It does not use persistent cookies to operate the queuing system. It is not designed to be switched off and back on again at the client terminal end.

It has a ‘Return Later’ option that allocates a soft key or pass to the client terminal, delivered by eMail, for example, that provides access to the front of the queue within a later time frame. The queue administrator sets the delay between issue time and earliest redemption time. The queue administrator can also set the length of time the soft key is valid for. Soft keys can be switched off permanently or temporarily per gate.

It allows one token to be issued to a unique client terminal. Even if the client terminal opens up multiple clients on the same machine, and believes that they have multiple places in the queue, when the token is created duplicates are denied and no access to the Entrance Gate can be achieved. Other systems use quite different, more intensive and complex 1^{st} and 2^{nd} encrypted strings.

The present invention allows a more efficient throughput of users/customers on a website. In addition, because the website is less likely to fail and customers are informed of their place in a queue, the usability of the website is increased and customers are more likely to select a website that incorporates the present invention for buying e.g. concert tickets or the like.

Improvements and modifications may be incorporated herein without deviating from the scope of the invention.

1. A system for managing requests for a service from one or more customer terminals, the system comprising:
a queue manager for receiving the requests for the service from the one or more customer terminals via one or more communications channels, the queue manager being adapted to place the requests for service in an ordered queue;
a service manager, responsive to the request for service, the service manager being adapted to deliver the service to the one or more customer terminals by means of one or more applications;
communication means adapted to pass data between the queue manager and the service manager, the data being related to an allowable volume of customer terminals granted access to the service manager;
wherein the queue manager holds the customer terminals not granted access to the service manager in the ordered queue once the allowable volume of customer terminals granted access to the service manager is reached and the communications channels between the queue manager and the customer terminals not granted access to the service manager are held open whilst the customer terminals are held in the ordered queue.

2. (canceled)

3. A system as claimed in claim 1 wherein a unique identifier is provided to each of the one or more customer terminals connected to the queue manager when placed in the ordered queue.

4. A system as claimed in claim 1 wherein, the queue manager comprises:
a request receiver for receiving a request for the service from the one or more customer terminals via the one or more communications channels; and
a customer manager for receiving data on the volume of customer terminals connected to the service manager, the data defining the allowable volume of customer terminals granted access to the service manager;
wherein the queue manager is adapted to hold open the communications channel with the customer terminal whilst the customer terminal is held in the queue.

5. A system as claimed in claim 1 wherein, the communications channel between each of the customer terminals and the queue manager is routed through a firewall and
the firewall grants a connection between the customer terminal and the queue manager if capacity is available.

6-7. (canceled)

8. A system as claimed in claim 1 wherein, the communication means sends data to the queue manager which calculates the allowable volume of customer terminals granted access to the service manager and determines whether a customer terminal in the ordered queue can pass to one or more core applications.

9. A system as claimed in claim 1 wherein, the communications means sends data on the allowable volume of customer terminals which has been calculated by the service manager such that the queue manager determines whether a customer terminal in the ordered queue can pass to the core applications.

10. A system as claimed in claim 1 wherein, a token is issued to the client terminal on leaving the queue to allow the client terminal to access the one or more core applications.

11-13. (canceled)

14. A system as claimed in claim 10 wherein, the token holds a unique identifier.

15. A system as claimed in claim 10 wherein the token having a unique identifier is compared with other tokens and suspected duplicate tokens denied access.

16. A system as claimed in claim 10 wherein, the unique identifier includes the customer terminal MAC address.

17. A system as claimed in claim 1 wherein, the communications channel is kept open by sending data to the customer terminal periodically.

18. A system as claimed in claim 17 wherein, the queue manager sends the data to the customer terminal.

19. A system as claimed in claim 17 wherein, the data comprises information on the position of the customer terminal in the queue.

20. A system as claimed in claim 17 wherein, less than one kilobyte of data is transferred.

21-25. (canceled)

26. A system as claimed in claim 1 wherein, multiple queues can be controlled by the system.

27. A system as claimed in claim 26 wherein, preference can be given to customer terminals located on one of said multiple queues.

28. A system as claimed in claim 1 wherein, queues from a plurality of web sites or sections of separate sites may be merged into a single queue.

29. A method for managing requests for service from a customer terminal, the method comprising the steps of:
receiving a request for service at a queue manager via a communications channel;
either passing the request to a service manager for processing or placing the request in an ordered queue depending upon whether one or more applications associated with the service manager are connected to an allowable number of customer terminals;
such that, where the request is placed in a queue the communications channel between the customer terminal and the queue manager is held open whilst the customer terminal is held in the queue.

30. (canceled)

31. A method as claimed in claim 29 wherein, each of the customer terminals connected to the queue manager are uniquely identified when placed in the ordered queue.

32. A method as claimed in claim 29 wherein, the communications channel that connects the customer terminals and the queue manager is routed through a firewall and
the firewall grants the connection between the customer terminal and the queue manager if capacity is available.

33. (canceled)

34. A method as claimed in claim 29 wherein, the allowable volume of customer terminals is calculated to determine whether a customer terminal in the ordered queue can pass to the core applications.

35. A method as claimed in claim 29 wherein, data is sent by the communications means said data relating to the allowable volume of customer terminals which has been calculated by the service manager such that the queue manager determines whether a customer terminal in the ordered queue can pass to the core applications.

36. A method as claimed in claim 29 wherein a token is issued to the client terminal on leaving the queue to allow the client terminal to access the one or more application associated with the service manager.

37-39. (canceled)

40. A method as claimed in claim 36 wherein, the token holds a calculated unique identifier.

41. A method as claimed in claim 40 wherein, the unique identifier is used to stop multiple queue entries by comparison with previous token unique identifiers denying suspected duplicates access.

42. A method as claimed in claim 40 wherein, the unique identifier includes the customer terminal MAC address.

43. A method as claimed in claim 29 wherein, the communications channel is kept open by sending data to the customer terminal periodically.

44. A method as claimed in claim 43 wherein, data is sent from the queue manager to the customer terminal.

45. A method as claimed in claim 43 wherein, the data comprises information on the position of the customer terminal in the queue.

46. A method as claimed in claim 43 wherein, the amount of data transferred is significantly less than that transferred when refreshing an internet page.

47. A method as claimed in any of claim 43 wherein, less than one kilobyte of data is transferred.

48-51. (canceled)

52. A method as claimed in any claim 29 wherein, multiple queues can be controlled by the system.

53. A method as claimed in claim 29 wherein, preference can be given to customer terminals located on one of said multiple queues.

54. A method as claimed in claim 52 wherein, queues from a plurality of web sites or sections of separate sites may be merged into a single queue.

55. (canceled)
